(19) United States
(12) Patent Application Publication
(10) Pub. No.: US 2002/0100342 A1
(43) Pub. Date: Aug. 1, 2002

(54) Vehicle steering wheel

(75) Inventors: Klaus Drefahl, Hanau (DE); Jupp Fleckenstein, Bessenbach (DE); Martin Kreuzer, Kleinwallstadt (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co. KG

(21) Appl. No.: 10/055,540

(22) Filed: Jan. 23, 2002

(30) Foreign Application Priority Data
Feb. 1, 2001 (DE) 201 01 868.3

(51) Int. Cl. B62D 1/04

(52) U.S. Cl. 74/552

(57) ABSTRACT

The invention relates to a vehicle steering wheel comprising a skeleton made of die cast material, a reinforcement being embedded in the die cast material.

### TECHNICAL FIELD

The invention relates to a vehicle steering wheel.

### BACKGROUND OF THE INVENTION

Vehicle steering wheels typically comprise skeletons that are produced increasingly from die cast material, in order to be able to manufacture the increasingly complicated shapes of the skeleton at all and in order to keep the weight as low as possible.

### BRIEF SUMMARY OF THE INVENTION

The invention provides a vehicle steering wheel comprising a skeleton which, with a low weight as before, has a higher strength than was known hitherto. This is achieved in a vehicle steering wheel comprising a skeleton made of die cast material, a reinforcement being embedded in the die cast material. This means that the reinforcement is preferably completely embedded into and surrounded by the die cast material, not attached to it from the exterior, for instance, so that no complicated manufacture is necessary. Further, the reinforcement holds die cast portions permanently together. The reinforcement is preferably a one-piece sheet metal having a higher tensile and flexural strength than the die cast material.

Preferably the reinforcement has through openings which are penetrated by the die cast material, so that a mechanical, form-fitting anchoring of the reinforcement in the die cast material is achieved at numerous sites. Also, a detaching of the die cast material from the reinforcement on fracture of the die cast material can therefore be prevented, irrespective of the fracture site.

The die cast material is preferably aluminum or magnesium and the metal sheet is steel or aluminum. With a metal sheet of aluminum or a reinforcement of aluminum, the advantage exists in addition that on recycling no separation of the aluminum reinforcement and of the aluminum die cast metal or magnesium die cast metal is necessary. Furthermore, the aluminum surface will slightly dissolve on inflow of the hot aluminum or magnesium, so that a type of solution composite is produced, which in addition to the mechanical anchoring of the reinforcement in the die cast metal provides an additional connection.

The skeleton has a hub section and at least one spoke originating therefrom. The reinforcement runs from the hub section as far as into the spoke; it can even run into the region of the steering wheel rim. As the fracture of a steering wheel preferably takes place at the transition of the spoke to the hub section, the reinforcement is provided in the particularly critical region of the steering wheel.

For this purpose, with the use of a metal sheet, provision is made that this has an annular part, extending axially and surrounding an opening in the hub section, and has a flat section originating from the annular part and comprising extensions protruding into the spokes. The annular part surrounds the hub and increases the stability of the hub, so that the metal sheet not only reinforces the transition from the hub section to the spoke, but the hub section itself. Therefore, less die cast material can be provided in the region of the hub section, which is advantageous in terms of reduction in weight.

### BRIEF DESCRIPTION OF THE DRAWINGS

FIG. 1 shows a perspective view of a skeleton of the vehicle steering wheel according to the invention;

FIG. 2 shows a top view onto a metal sheet which is embedded into the skeleton according to FIG. 1;

FIG. 3 shows a side view of the metal sheet of FIG. 2; and

FIG. 4 shows a sectional view through a part of the skeleton of FIG. 1 in the region of the hub section and of a spoke.

### DETAILED DESCRIPTION OF THE PREFERRED EMBODIMENTS

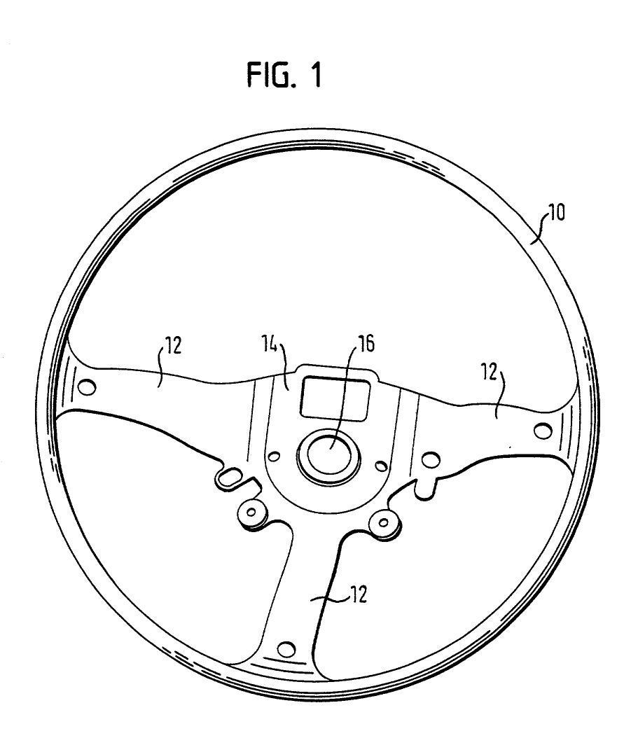

In FIG. 1 a vehicle steering wheel is illustrated, more precisely its skeleton, which has various sections, namely a rim 10, spokes 12 and a hub section 14, from which the spokes 12 originate. The hub section 14 has, in addition, a central opening 16 to subsequently receive a steering column. The skeleton consists of aluminum- or magnesium die cast material.

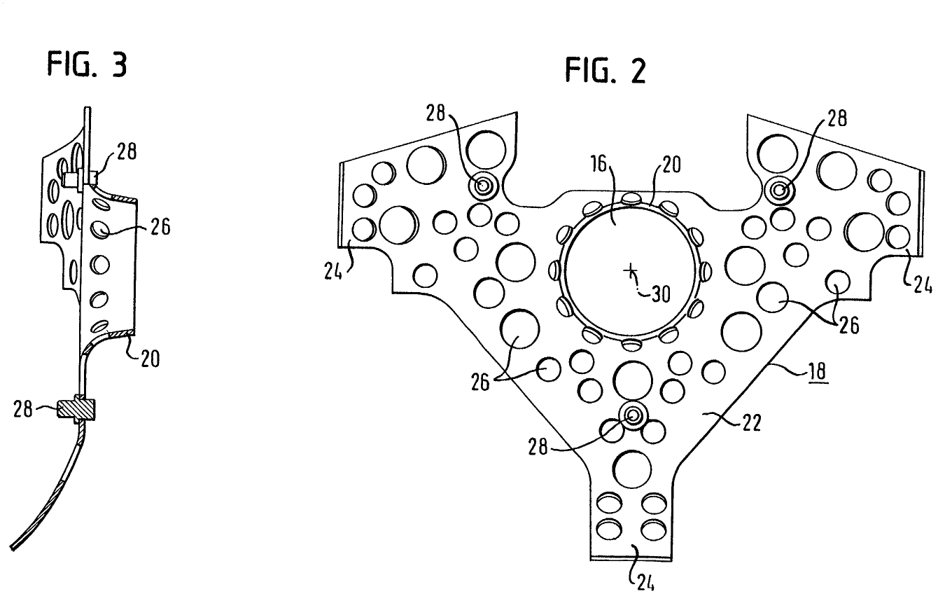

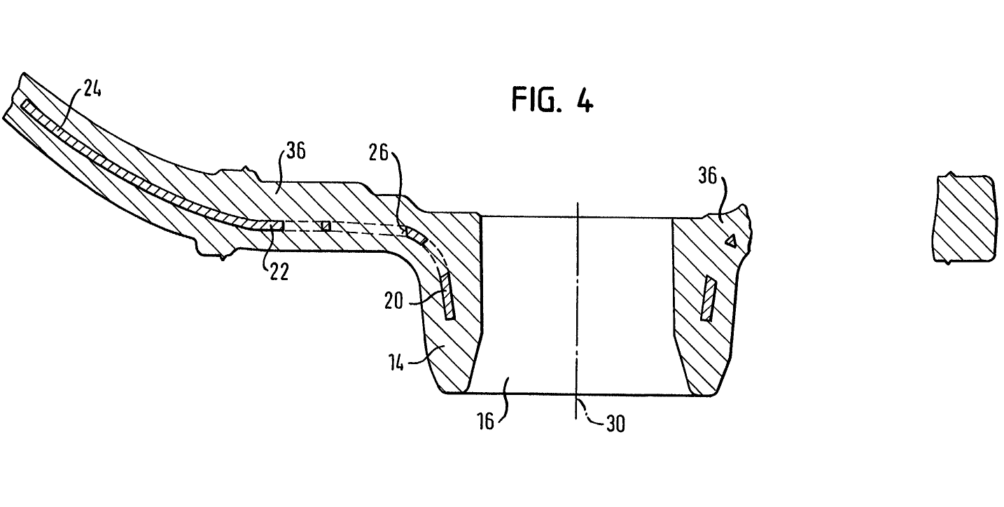

A metal sheet 18 illustrated in FIGS. 2 and 3 forms a reinforcement which is embedded in the die cast material, as can be seen more precisely from FIG. 4. The metal sheet 18 has an annular part 20 extending axially (axially means in the direction of the imaginary axis 30 of the opening 16) and surrounding the opening 16 in the hub section 14, and a flat section 22 originating from the annular part and comprising extensions 24 which are slightly bent following the shape of the spokes. The metal sheet 18 is produced by stamping and subsequent deep-drawing. The metal sheet 18 has a plurality of through openings 26 both in the region of the annular part 20 and also in all other sections. Three holding pins 28 which lie around the axis 30 at a 120° distance from each other, are pressed into openings and serve to hold the metal sheet in a die casting mold, so that the metal sheet 18 has the desired distance from the inner side of the mold. Hence, the metal sheet which consists of steel or aluminum is positioned in the die casting mold by means of the pins 28. Then aluminum or magnesium is introduced, which completely surrounds the metal sheet, so that the latter is embedded in the die cast material, as FIG. 4 shows. The pins 28 can, but do not have to, be removed. As the die cast material also penetrates the openings 26, a good mechanical binding of the metal sheet 18 into the die cast material is produced, which is given the reference number 36 in FIG. 4.

The skeleton which is manufactured in this way offers a vehicle steering wheel, which does not allow any free parts to arise.

The metal sheet 18 is approximately 1 mm thick if it is of steel, and is approximately 2 mm thick if it is of aluminum.

1. A vehicle steering wheel, comprising
a skeleton made of die cast material,
a reinforcement being embedded in said die cast material.

2. The vehicle steering wheel according to claim 1, wherein said reinforcement has through openings which are penetrated by said die cast material.

3. The vehicle steering wheel according to claim 1, wherein said skeleton has a hub section and at least one spoke originating therefrom and wherein said reinforcement runs from said hub section as far as into said spoke.

4. The vehicle steering wheel according to claim 1, wherein said reinforcement is a metal sheet.

5. The vehicle steering wheel according to claim 4, wherein said metal sheet is made of one of steel and aluminum.

6. The vehicle steering wheel according to claim 1, wherein said die cast material is one of aluminum and magnesium.

7. The vehicle steering wheel according to claim 4, wherein said metal sheet has an annular part extending axially and surrounding an opening in said hub section, and has a flat section originating from said annular part and comprising extensions protruding into said spokes.

8. The vehicle steering wheel according to claim 1, wherein pins are provided on said reinforcement for positioning said reinforcement during die casting.

9. The vehicle steering wheel according to claim 1, wherein said reinforcement is completely surrounded by said die cast material.
